(19) United States
(12) Patent Application Publication
(10) Pub. No.: US 2018/0283919 A1
(43) Pub. Date: Oct. 4, 2018

(54) FLOW SENSOR

(71) Applicant: KOA CORPORATION, Nagano 3960025 (JP)

(72) Inventor: Tomokazu IKENO, Nagano (JP)

(73) Assignee: KOA CORPORATION, Nagano (JP)

(21) Appl. No.: 15/765,051

(22) PCT Filed: Sep. 30, 2016
(86) PCT No.: PCT/JP2016/079001

§ 371 Date: Mar. 30, 2018

(30) Foreign Application Priority Data
Oct. 2, 2015 (JP) 2015-196674

(51) Int. Cl. G01F 1/69; G01F 1/698

(52) U.S. Cl. CPC G01F 1/69; G01F 1/698

(57) ABSTRACT

Provided is a flow sensor capable of suppressing deterioration in responsiveness and sensitivity to a flow of fluid even if chip resistors that are disposed on an insulating substrate are used as a heating resistor and a temperature compensating resistor. A flow sensor includes a signal processing part that processes signals from a heating resistor and a temperature compensating resistor. The heating resistor is a chip resistor disposed on a front surface of an insulating substrate made of resin, and the temperature compensating resistor is a back surface of the insulating substrate. The temperature compensating resistor is disposed on a heat radiation path of the heating resistor via the insulating substrate. The insulating substrate has reduced opportunities of contact between the temperature compensating resistor and wind than opportunities of contact between the heating resistor and the fluid.

### TECHNICAL FIELD

The present invention relates to a flow sensor.

### BACKGROUND ART

There has been known a flow sensor that detects a flow of fluid by using heat radiation of a heating element corresponding to an amount of the fluid. The flow sensor of this type has a publicly known resistor-bridge circuit constituted by a heat generating resistor (heating element) and a temperature compensating resistor. The heating resistor is controlled for heating so that its temperature is higher than the temperature of the fluid by a certain temperature. The temperature compensating resistor detects the temperature of the fluid itself and is used in order to compensate for an influence of a change in fluid temperature.

On the basis of this technology, there has been proposed a flow sensor that includes a heating resistor and a temperature compensating resistor, which are both chip resistors, disposed on an insulating substrate so as to be close to each other (see Patent Literatures 1 and 2).

### CITATION LIST

### Patent Literatures

Patent Literature 1: Japanese Unexamined Patent Application Publication No. 09-53967.

Patent Literature 2: Japanese Unexamined Patent Application Publication No. 08-35978.

### SUMMARY OF INVENTION

However, the flow sensor that includes, in a form descried in the above patent literatures, a heating resistor and a temperature compensating resistor, which are both chip resistors, disposed on an insulating substrate so as to close to each other is generally inferior in responsiveness and sensitivity to a flow of fluid.

Accordingly, it is an object of the present invention to provide a flow sensor capable of suppressing deterioration in responsiveness and sensitivity to a flow of fluid even in the case of using, as a heating resistor and a temperature compensating resistor, chip resistors disposed on an insulating substrate.

To achieve the above object, the flow sensor of the present invention has a signal processing part that processes a heating resistor and a temperature compensating resistor, in which the flow sensor detects a flow rate of fluid by using heat radiation of the heating resistor; the heating resistor and the temperature compensating resistor are chip resistors disposed on an insulating substrate; the temperature compensating resistor is disposed on a heat radiation path of the heating resistor via the insulating substrate; and opportunities of contact between the temperature compensating resistor and the fluid are reduced than opportunities of contact between the heating resistor and the fluid.

Here, the temperature compensating resistor may be disposed on the insulating substrate surface opposite to the surface on which the heat generating resistor is disposed.

In addition, the flow sensor may further comprise a holding member that holds the insulating substrate. The holding member may include a recess part; and the insulating substrate may be fitted into the recess part so that the one surface of the insulating substrate on which the temperature compensating resistor is disposed faces the recess part.

In addition, the flow sensor may comprise a heat insulator that covers the whole or a part of the temperature compensating resistor.

The present invention can provide a flow sensor capable of suppressing deterioration in responsiveness and sensitivity to a flow of fluid even if chip resistors that are disposed on an insulating substrate are used as a heating resistor and a temperature compensating resistor.

### BRIEF DESCRIPTIONS OF DRAWINGS

FIG. 1 shows a plan view of a flow sensor according to an embodiment of the present invention.

FIG. 2 shows a schematic diagram of a circuit constituting the flow sensor according to the embodiment of the present invention.

FIG. 3A shows an insulating substrate according to the embodiment of the present invention.

FIG. 3B shows a holding member that holds the insulating substrate according to the embodiment of the present invention.

FIG. 4 shows a graph showing temporal changes of wind speeds output by a flow sensor 1a according to an embodiment of the present invention, a comparative flow sensor, and a reference anemometer when an air tunnel is externally controlled to send a wind having the same magnitude to the flow sensor 1a, the comparative flow sensor, and the reference anemometer.

### DESCRIPTION OF EMBODIMENTS

A flow sensor according to an embodiment of the present invention will be described below with reference to the drawings.

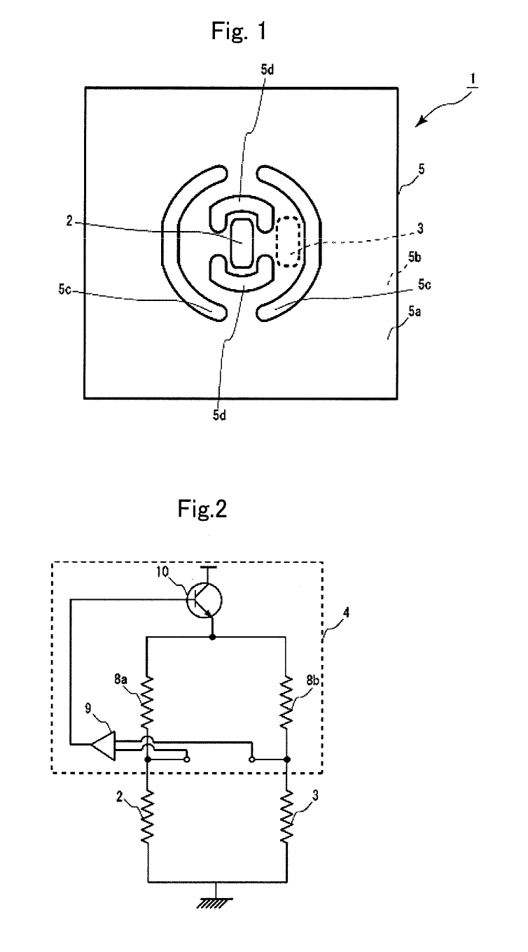

FIG. 1 is a plan view of the flow sensor according to the embodiment of the present invention. FIG. 2 is a schematic diagram of a circuit constituting the flow sensor according to the embodiment of the present invention.

The flow sensor 1 according to the embodiment of the present invention includes a heating resistor 2 and a signal processing part 4 that processes a signal from a temperature compensating resistor 3. The illustration of signal processing part 4 is omitted in FIG. 1. Here, the heating resistor 2 serves to detect a flow amount of fluid by using its radiation of heat. The temperature compensating resistor 3 serves to detect the temperature of fluid itself and to compensate for an influence of change in fluid temperature.

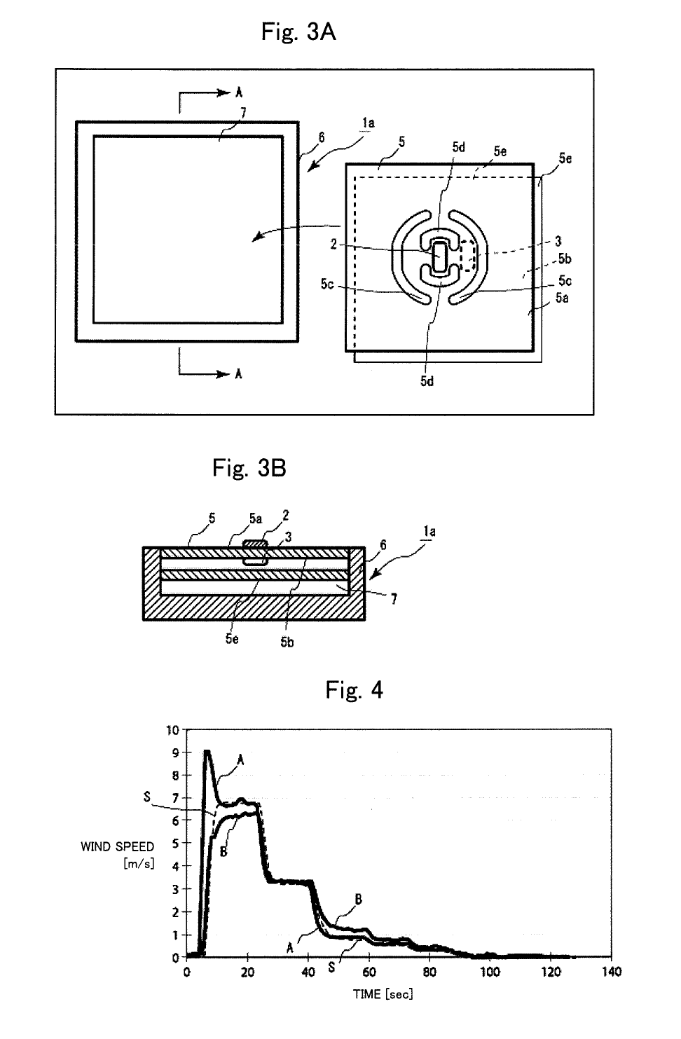

The heating resistor 2 is a chip resistor disposed on a front surface 5a of an insulating substrate 5 made of resin. Also, the temperature compensating resistor 3 is a chip resistor disposed on a back surface 5b of the insulating substrate 5. In such dispositions of the heating resistor 2 and the temperature compensating resistor 3, the temperature compensating resistor 3 is disposed on a heat radiation path of the heating resistor 2 via the insulating substrate 5. The signal processing part 4 is disposed on an insulating substrate 5e (shown in FIG. 3A described later) that is provided separately from the insulating substrate 5 and that is identical in outer shape to the insulating substrate 5. In the insulating substrate 5, two slits 5c and two slits 5d are formed. The slits 5c, 5c, 5d and 5d serve to adjust ease (thermal resistance) of heat transmission from the heating resistor 2 to the temperature compensating resistor 3 via the insulating substrate 5 to be suitable.

The reason that the temperature compensating resistor 3 is disposed on the heat radiation path of the heating resistor 2 via the insulating substrate 5 is caused by forming both the heating resistor 2 and temperature compensating resistor 3 into a chip shape and disposing them on the insulating substrate 5. The chip resistors of this type do not radiate Joule heat only by ambient wind, but radiate Joule heat to the insulating substrate 5 through a pair of terminal electrodes. If the heating resistor 2 and the temperature compensating resistor 3 are disposed so that the temperature of the temperature compensating resistor 3 becomes equal to the temperature of fluid regardless of the heat radiation of the heating resistor 2, a thermal time constant caused by a thermal capacity of the insulating substrate 5 is fully included in temperature control of the heating resistor 2. This remarkably deteriorates the responsiveness of the flow sensor 1. By disposing the temperature compensating resistor 3 on the heat radiation path of the heating resistor 2, and setting the temperatures of the terminal portions of the heating resistor 2 and the temperature compensating resistor 3 to be uniform as much as possible, an influence of a thermal time constant caused by the thermal capacity of the insulating substrate 5 is reduced, so that responsiveness of control of the signal processing part 4 that controls a difference in temperature of the heating resistor 2 and temperature compensating resistor 3 can be maintained to be high.

Here, a flow sensor 1a in which a holding member 6 has been added to the flow sensor 1, according to an embodiment of the present invention, will be described. FIGS. 3A and 3B illustrate the insulating substrate 5, an insulating substrate 5e, and the holding member 6, which hold the insulating substrate 5 and 5e. Similarly to FIG. 1, FIG. 3A illustrates the insulating substrate 5 in planar view. The flow sensor 1a according to the embodiment of the present invention further includes the holding member 6 for holding the insulating substrate 5. As shown in FIG. 3B, the holding member 6 has a recess part 7. In addition, the insulating substrate 5 is fixedly fitted into the recess part 7 so that the back surface 5b of the insulating substrate 5 faces the recess part 7.

FIG. 3A illustrates that the insulating substrate 5 and the insulating substrate 5e are moved in the arrow direction and are fitted into the recess part 7 of the holding member 6. In addition, FIG. 3B is a sectional view taken on the line A-A in FIG. 3A after the insulating substrate 5 and the insulating substrate 5e are fitted into the recess part 7. As shown in FIG. 3B, the insulating substrate 5e on which the signal processing part 4 is disposed is prevented from being exposed from the holding member 6, and is fixedly fitted into the recess part 7 so as to be superposed over the insulating substrate 5. Note that in FIG. 3B, the illustration of the signal processing part 4 and the slits 5c and 5d are omitted.

Since the heating resistor 2 does not face the recess part 7 as described above, the heating resistor 2 is exposed to external air. Accordingly, in a case where wind is sent to the side of the front surface 5a of the insulating substrate 5, the insulating substrate 5 can function as a barrier member that reduces opportunities of contact between the temperature compensating resistor 3 and wind (fluid) than opportunities of contact between the heating resistor 2 and wind. In other words, in this case, the insulating substrate 5 serves also as the barrier member. This also applies to the flow sensor 1 that does not have the holding member 6.

Here, in a case where the heating resistor 2 and the temperature compensating resistor 3 are disposed on each of the front and back surfaces of the insulating substrate 5, the insulating substrate 5 does not always serve as the barrier member. For example, in the flow sensor described in the Patent Literature 1, an insulating substrate has an opening in its part, and a heating resistor and a temperature compensating resistor are disposed on each of the front and back surfaces of the insulating substrate, with the opening sandwiched therebetween. Such an insulating substrate is not said to be a barrier member since it does reduce opportunities of contact between the temperature compensating resistor and a fluid than opportunities of contact between the heating resistor and the fluid.

The heating resistor 2 and the temperature compensating resistor 3 of each of the flow sensors 1 and 1a, and the resistors 8a and 8b, which are chip-shaped, constitute a publicly known voltage-dividing circuit, as shown in FIG. 2. The signal processing part 4 includes the resistors 8a and 8b, an operational amplifier 9, and a transistor 10 (other components of the signal processing part 4 are not shown). Here, a temperature coefficient of resistance (TCR) of the heating resistor 2 and the temperature compensating resistor 3 is greater than a TCR of the resistors 8a and 8b.

A wind is sent to the side of the front surface 5a of the insulating substrate 5 of each of the flow sensors 1 and 1a by, for example, fanning a fan. Then, the temperature of the heating resistor 2 deceases. The signal processing part 4 applies a driving voltage to the heating resistor 2 so that a difference in temperature between the heating resistor 2 and the temperature compensating resistor 3 is always constant. The flow sensor 1a outputs a flowing rate (wind speed) of the fluid in converted form by using a change in voltage needed for the above-mentioned heating. The intensity or the like of output flowing rate (wind speed) is represented by an amount of light, an emission color, or the like, of an LED (Light Emitting Diode). For example, when the wind speed of wind is high, the amount of light of the LED is increased (brightened), while when the wind speed of wind is low, the amount of light of the wind speed is decreased (darkened), or the wind speed is displayed as a specific numeric value.

### Experiment

Prepared was a comparative flow sensor identical in configuration to the flow sensor 1a according to the embodiment of the present invention except that the heating resistor 2 was disposed on the front surface 5a of the insulating substrate 5. This comparative flow sensor had the temperature compensating resistor 3 disposed on a heat radiation path of the heating resistor 2 via the insulating substrate 5 similarly to the flow sensor 1a.

FIG. 4 is a graph showing temporal changes of wind speeds output by the flow sensor 1a, the comparative flow sensor, and a reference anemometer when an air tunnel was externally controlled to send a wind having the same magnitude to those by the flow sensor 1a, the comparative flow sensor, and the reference anemometer.

Here, as the reference anemometer, a calibrated anemometer (System 6244 made by KANOMAX JAPAN INCORPORATED) was used. In FIG. 4, the wind speed, as a reference, output by the reference anemometer is represented by a broken line (S). Regarding the wind speed, as a reference, in a case where the wind was sent twice in the same conditions by using the above tunnel, wind speed nearly identical the broken line (S) in FIG. 4 was output, thus indicating that reproducibility was obtained.

FIG. 4 indicates that a wind speed (represented by solid line B) output by the comparative flow sensor is inferior in responsiveness and sensitivity compared to the wind speed (represented by solid line A) output by the flow sensor 1a. In particular, after the start of sending the wind in 10 or more seconds, at which the wind speed begins to be stable, the tendency is obvious. The reason is that the temperature compensating resistor 3 had a temperature higher than room temperature since the temperature compensating resistor 3 was disposed on the heat radiation path of the heating resistor 2 via the insulating substrate 5.

In other words, if the temperature compensating resistor 3 can be disposed in a temperature environment equivalent to the case of room temperature, in a place where it is difficult for the temperature compensating resistor 3 to greatly change in temperature when being in contact with wind, that is, the temperature compensating resistor 3 is disposed in a high temperature environment. In this case, the temperature of the temperature compensating resistor 3 greatly changes when the temperature compensating resistor 3 easily contacts wind. Then, when the signal processing part 4 applies a driving voltage to the heating resistor 2 so that a difference in temperature between the heating resistor 2 and the temperature compensating resistor 3 is always constant, the signal processing part 4 applies an error voltage. This is a cause that the comparative flow sensor was inferior in responsiveness and sensitivity.

Results of the flow sensor 1a in FIG. 4 were nearly identical to results obtained from a case where a so-called KAPTON (registered trademark) adhesive tape, which contains a main component of polyimide film as a heat insulator, was wound three times around the temperature compensating resistor 3 of the comparative flow sensor before the temperature compensating resistor 3 was coated. In other words, reduced opportunities of contact between the temperature compensating resistor and wind cause the flow sensor 1a according to the embodiment of the present invention to have good responsiveness and sensitivity.

### Main Advantage Obtained by the Embodiments

The flow sensors 1 and 1a according to the embodiments of the present invention can each suppress deterioration in responsiveness and sensitivity to wind (fluid) even in the case of using, as the heating resistor 2 and the temperature compensating resistor 3, chip resistors that are disposed on the insulating substrate 5.

In addition, the flow sensors 1 and 1a according to the embodiments each use, as the heating resistor 2 and the temperature compensating resistor 3, chip resistors that are disposed on the insulating substrate 5. It is mainstream to use, as a heating resistor and a temperature compensating resistor for use in a flow sensor, not chip resistors but resistors with leads. However, the resistors with leads have weak mechanical strength and are expensive since platinum is used as a main material. In this respect, the chip resistors have advantages of excellent mechanical strength and inexpensive manufacturability.

In addition, the flow sensors 1 and 1a each includes the temperature compensating resistor 3 disposed on the heat radiation path of the heating resistor 2 via the insulating substrate 5. Accordingly, the temperatures of the heating resistor 2 and the temperature compensating resistor 3, in particular, the temperatures of their terminal portions can be made uniform. Thus, when measuring wind speed, and in particular, in the case of no wind, control responsiveness in temperature control of the heating resistor 2 can be enhanced.

In addition, the flow sensor 1a according to the embodiment of the present invention includes the holding member 6 that holds the insulating substrate 5, and the holding member 6 has the recess part 7. The insulating substrate 5 is fixedly fitted into the recess part 7 so that the back surface 5b of the insulating substrate 5 faces the recess part 7. This causes the heating resistor 2 to be exposed to external air, so that in the heating resistor 2, there are increased opportunities of contact with wind.

### Other Embodiments

The above-described flow sensor 1 and 1a according to the embodiments of the present invention are suitable examples of the present invention. However, the present invention is not limited by them and can be variously modified without changing its gist.

For example, the flow sensors 1 and 1a according to the embodiments of the present invention each include the heating resistor 2 disposed on the front surface 5a of the insulating substrate 5, and the temperature compensating resistor 3 disposed on the back surface 5b of the insulating substrate 5. However, the heating resistor 2 and the temperature compensating resistor 3 may be disposed on the same surface of the insulating substrate 5 as in the case of the above-described comparative flow sensor.

Further, the signal processing part 4 is disposed on an insulating substrate e different from the insulating substrate 5 on which the heating resistor 2 and the temperature compensating resistor 3 are disposed. However, the signal processing part 4 may be disposed on the insulating substrate 5 on which the heating resistor 2 and the temperature compensating resistor 3 are disposed.

In addition, the flow sensors 1 and 1a each include the temperature compensating resistor 3 disposed on the heat radiation path of the heating resistor 2 via the insulating substrate 5. This is because the temperature differences of the terminal portions of the heating resistor 2 and the temperature compensating resistor 3 can easily made uniform. Accordingly, if this state can be maintained, it is not necessary to dispose the temperature compensating resistor 3 on the heat radiation path of the heating resistor 2 via the insulating substrate 5. For example, the temperature compensating resistor 3 may be disposed on the insulating substrate 5e on which the signal processing part 4 is disposed.

In addition, it may be unnecessary to form the two slits 5c and the two slits in the insulating substrate 5 if thermal conductibility (thermal resistance) of heat from the heating resistor 2 to the temperature compensating resistor 3 via the insulating substrate 5 is suitable.

In addition, the flow sensor 1a according to the embodiment of the present invention includes the holding member 6 that holds the insulating substrates 5 and 5e. However, the holding member 6 can be omitted since it is not an essential component. However, since the flow sensor 1a employs a configuration in which the insulating substrate 5 is fitted into the holding member 6, the insulating substrate 5 serves also as a barrier member. If the holding member 6 is omitted, it is necessary to reduce opportunities of contact between the temperature compensating resistor 3 and wind than opportunities of contact between the heating resistor 2 and wind.

In addition, in each embodiment of the present invention, the barrier member is used as the insulating substrate 5, but is not limited thereto. For example, a heat insulator that covers the whole or a part of the temperature compensating resistor 3 can be used as the barrier member. As this heat insular, for example, an adhesive tape, a bond, a formable material, or the like, can be used.

In addition, the flow sensors 1 and 1a according to the embodiments of the present invention have been made targeting wind speed sensors directed to winds (gas, air, atmosphere) as fluids. However, the present invention is applicable to flow sensors directed to liquids other than winds, for example, liquids such as water.

In addition, the flow sensors 1 and 1a each include the barrier member. However, depending on the configuration of the flow sensor 1, opportunities of contact between the temperature compensating resistor 3 and wind may be reduced than opportunities of contact between the heating resistor 2 and wind by means of not using the barrier member. The means includes, for example, a layout of the heating resistor 2 and the temperature compensating resistor 3.

This application is based on JP Application No. 2015-196674 filed on Oct. 2, 2015. All of the contents of this application are incorporated herein.

1. A flow sensor comprising:
a signal processing part that processes signals from a heating resistor and a temperature compensating resistor,
wherein:
the flow sensor detects a flow rate of fluid by using heat radiation of the heating resistor,
the heating resistor and the temperature compensating resistor are chip resistors disposed on an insulating substrate;
the temperature compensating resistor is disposed on a heat radiation path of the heating resistor via the insulating substrate; and
opportunities of contact between the temperature compensating resistor and the fluid are reduced than opportunities of contact between the heating resistor and the fluid.

2. The flow sensor according to claim 1,
wherein the temperature compensating resistor is disposed on one surface of the insulating substrate, the one surface being reverse to a surface on which the heating resistor is disposed.

3. The flow sensor according to claim 2,
further comprising a holding member that holds the insulating substrate,
wherein:
the holding member includes a recess part; and
the insulating substrate is fitted into the recess part so that the one surface of the insulating substrate on which the temperature compensating resistor is disposed faces the recess part.

4. The flow sensor according to claim 1,
comprising a heat insulator that covers the whole or a part of the temperature compensating resistor.
